(19) United States
(12) Patent Application Publication
(10) Pub. No.: US 2007/0007763 A1
(43) Pub. Date: Jan. 11, 2007

(54) Adaptor fitting

(76) Inventor: Randall A. Deaton, Chesterton, IN (US)

Correspondence Address: Nancy S. Iatarola, 371 Spring View, Porter, IN, 46304, US

(21) Appl. No.: 11/175,278

(22) Filed: Jul. 7, 2005

(51) Int. Cl. F16L 43/00; F16L 13/02

(52) U.S. Cl. 285/179; 285/288.1

(57) ABSTRACT

This invention relates to fittings for connection of pipes. In particular this invention involves a fitting receptacle which fits over a fitting. The fitting receptacle fits over universal and standard fittings and can receive pipe to make a connection between an existing fitting and pipe. The invention also involves a method of installing the fitting receptacle over an existing fitting.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

This invention relates to couplings for formation of pipe joints, and in particular to plumbing fittings. A fitting is a preformed coupling for joining pipe to pipe.

In one aspect, the invention relates to a preformed adaptor fitting receptacle which can be bonded between an existing fitting and pipe. In another aspect the invention relates to a preformed adaptor fitting receptacle which can be welded to an existing fitting and a new metal pipe. A tubular fluid conduit can encompass and be welded to an existing fitting and a new pipe. In another aspect, the invention relates to a method for coupling the new pipe and the existing fitting in a field environment utilizing the fitting receptacle.

While the use of joint couplings or fittings to form pipe joints is well known, most such couplings are used to join plastic pipe to plastic pipe or join metal pipe to metal pipe. It is generally preferred to join plastic pipe to plastic pipe by heat fusion or adhesives and to join metal pipe to metal pipe by welding. In recent years, the usage of plastic pipe, mainly polyvinyl chloride, to repair, extend or replace plumbing systems has increased substantially. In many instances, this has resulted in the need to connect a new plastic pipe to an existing plastic pipe. However, making a field installation of new plastic pipe or new steel pipe sometimes presents difficulties in view of many obstacles encountered.

Several types of transition fittings have been utilized commercially. Most of the pipe couplers have been designed as universal fittings. 1987 Annual Book of ASTM Standards, Volume 08.04 Plastic Pipe and Building Products. Those universal fittings are used to join any combination of plastic pipes. Some factory made transition fittings have been designed with plastic fittings on each end and various bends there between. While this may not be a problem where the metal pipe or the plastic pipe is readily moveable, it can represent a serious problem where both the plastic pipe and the metal pipe are restrained and the fitting, has been cut to exactly fit the gap between the free end of the plastic pipe or the free end of the metal pipe. The resulting universal fitting is generally within plain view or within an easily accessible work space. However, the pipe necessary for installation of a new fitting is not accessible. Therefore, substitution of fittings requires cleavage of pipe, makes repair difficult, and thereby necessitates additional coupling means. In prior art, fittings generally fit in between and join pipe to pipe.

### SUMMARY OF THE INVENTION

It is an object of this invention to provide a new adaptor fitting receptacle for coupling plastic pipe to plastic pipe and metal pipe to metal pipe. It is an object of the invention to provide a preformed adaptor fitting receptacle which makes the proper orientation of the fitting receptacle readily obvious to the user without any additional effort on the part of the user. It is an object of the invention to provide, an adaptor fitting receptacle which permits bonding of plastic pipe to plastic pipe and fusion of metal pipe to metal pipe.

Another object of the invention is to eliminate the problem of shortening the pipe length when the fitting is already in existence. A further object of the invention is to maintain the fitting in existence. The fitting receptacle fits over an existing fitting and pipe is inserted within the fitting receptacle.

Another object of the invention is to provide a low cost, high integrity adaptor fitting receptacle. This invention overcomes the foregoing difficulties and achieves the foregoing objects by providing a preformed coupling with the fitting receptacle having sufficient size to telescope over the free end of the fitting to be joined and the pipe to be joined. The preformed fitting receptacle can be provided with suitable retention means to resist any retraction of the fitting from the fitting receptacle. The preformed fitting receptacle also comprises means to resist retraction of pipe from the fitting receptacle. Other objects, aspects, and advantages of the invention will be apparent from the drawings and the following description of the invention.

### BRIEF DESCRIPTION OF THE DRAWINGS

FIG. 1 is a cross-sectional view of a fitting receptacle in accordance with one embodiment of the invention and

FIG. 2 is a cross-sectional view, of a fitting receptacle being telescoped over an existing fitting.

### DETAILED DESCRIPTION OF THE INVENTION.

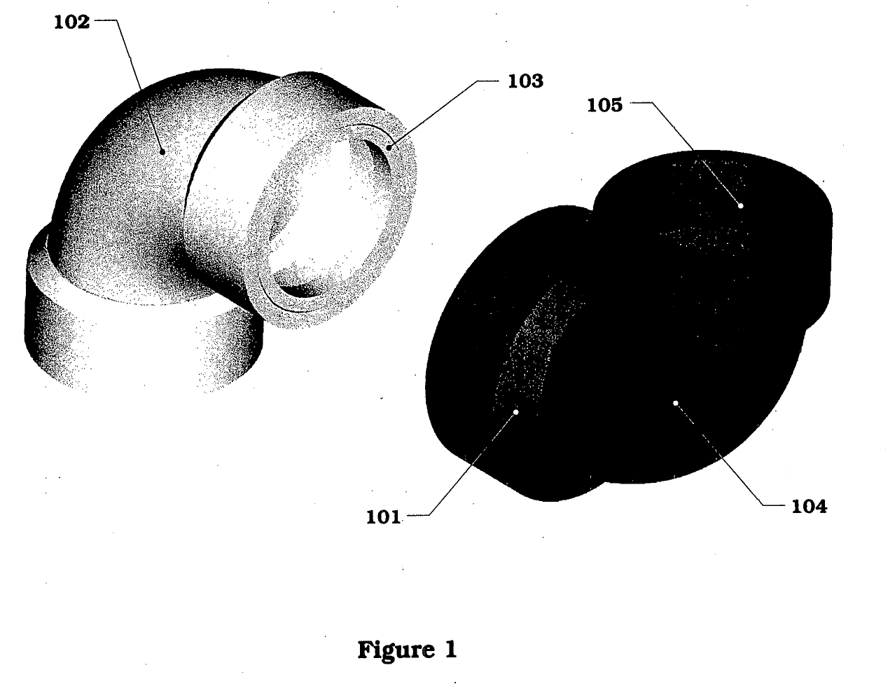

Referring now to FIG. 1, the fitting receptacle 101 comprises a tubular member 104. The substantially cylindrical end segments 101 and 105 form the first and second open ends, respectively. Substantially cylindrical 101 has an internal diameter which at most only slightly exceeds, the normal outside diameter of the existing fitting 102. The fitting receptacle 101 has a cylindrical inner surface significant to engage significant mechanical contact with existing fitting 102. Substantially cylindrical 105 has an internal diameter slightly greater than the outside diameter of the pipe to be connected. The pipe 103 remains joined to the existing fitting 102 while the fitting receptacle 101 fits over the existing fitting 102. The central segment could be curved, have an angle, or be straight. Existing fitting 102 extends longitudinally through the opening of fitting receptacle 101. Pipe 103, therefore, extends such that the end portion of the pipe 103 is positioned inside generally the fitting receptacle 101.

The internal diameter of each of the ends of the fitting receptacle 101 and connection member 105 is greater than pipe to be connected. Polyvinyl chloride pipe for plumbing applications consists of a diameter of most generally ¾ inch and 1½ inch. The preferred embodiment involves pipe fitting 102 designed to fit ¾ inch polyvinyl chloride pipe fittings used in plumbing applications. Another preferred embodiment involves fitting 102 designed to fit 1½ inch polyvinyl chloride pipe fittings used in plumbing applications.

The mechanical engagement of fitting receptacle 101 involves a fitting receptacle inner surface area slightly larger than an existing fitting 102. A preferred embodiment involves the fitting receptacle 101 having an inner surface area to form a sealing engagement with an existing fitting 102. Another embodiment involves having on the pipe fitting 102 exterior a layer of adhesive for bonding.

The fitting receptacle 101 is slightly greater than the normal external diameter of fitting 102. After the forming operation a mechanical engagement exists between fitting receptacle 101 and fitting 102. Pipe 103 preferably extends within fitting receptacle 101.

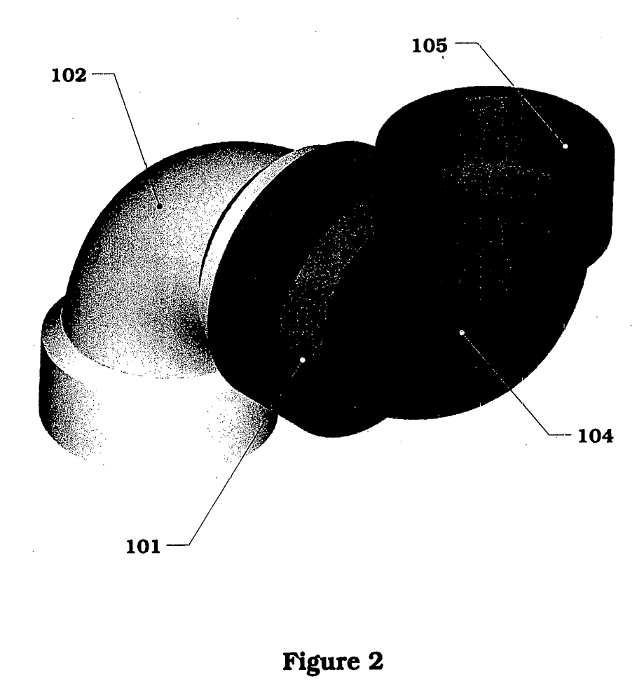

Referring also to FIG. 2, the fitting receptacle 101 is placed over fitting 102 and pipe 103 remains inside fitting receptacle such that fluid flow extends through pipe 103 and fitting receptacle 101. While polyvinyl chloride elements have been illustrated, any suitable substance can be employed. Substances such as polymers made from vinyl compounds, organosilicon, and metals work in this invention. However, it is preferred that the substances provide essentially continuous contact around the periphery of pipe 103 when the fitting receptacle 101 is connected to another pipe.

Existing fitting 102 is inserted into fitting receptacle 101. An end of the plastic tube comes to rest upon the second end of the connection member 105. At this point the sealing elements are actuated to cause the sealing of fitting receptacle 101 to form a fluid tight seal to existing fitting 102. Pipe moves inwardly to contact the diameter of the connection member 105.

FIG. 1 illustrates a tubular construction wherein the tube member with a first end and a second end has the fitting receptacle on the first end and the connection member on the second end of the tube member. The tubular construction can comprise the fitting receptacle with a diameter sufficient to mount a 1½ inch O fitting. The tubular construction also involves the fitting receptacle with a diameter sufficient to mount a ¾ inch O fitting.

A preferred embodiment involves the connection member comprising means to receive a 1½ inch polyvinyl chloride pipe. The tubular construction also includes the connection member comprising means to receive a ¾ inch polyvinyl chloride pipe.

The substances for making the tubular construction are selected from the group consisting of metal(s), polymers, and organosilicon compounds, copper, steel, iron, siloxanes, polyvinyl chloride, polybutylene, polypropylene, and polyester.

Some methods of sealingly attaching the fitting receptacle to the fitting involve adhesive on the exterior of pipe fitting and pipe. Other methods include welding and heat sealing.

The tubular construction also involves application wherein the pipe is a fluid flow pipe, the connection member is a universal fitting, the fitting receptacle comprises means to mount the universal fitting, and the construction forms a plumbing connection for fluid flow there through. The tubular construction according to this invention also involves connection members having a first internal step means for abutment against an end of a pipe, the fitting receptacle having a second internal step means for abutment against an end of a universal fitting. Another aspect of this invention involves the tubular construction having the internal diameter of the connection member receiving fluid flow when the pipe and the universal fitting received within the connection member are at least as large as the internal diameter of the tube member such that flow through the connection member is not restricted with respect to flow through the tube member.

A method for forming a tubular construction according to this invention involve sealing the polyvinyl chloride pipe member and the polyvinyl chloride fitting by mounting the polyvinyl chloride fitting receptacle about the exterior circumference of the existing polyvinyl chloride fitting, disposing an end of the polyvinyl chloride pipe member within the connection member opening in the polyvinyl chloride fitting receptacle fitting, and then rotating the pipe member at a sufficient speed and for a sufficient period of time to form separate fluid-tight substantially concentric and coaxial friction welds between the polyvinyl chloride pipe member, the polyvinyl chloride fitting, and the polyvinyl chloride fitting receptacle. Prior to rotating the polyvinyl chloride pipe member, an interference fit is formed between the polyvinyl chloride pipe and each of the polyvinyl chloride pipe receptacle and the fitting.

A preferred method of forming the sealed, tubular connection between the pipe fitting and the fitting receptacle involves the steps of: mounting the fitting receptacle about a universal fitting and disposing an end of the pipe member into the connection member. The method also includes mounting fitting receptacle on the fitting, disposing the pipe within the fitting receptacle, applying adhesive, and sliding together.

Another embodiment includes a plumbing construction comprising a fluid conduit, the fitting receptacle at one end of the fluid conduit, and the fitting at the second end of the fluid conduit. The plumbing construction has an internal diameter greater than the exterior diameter of the fitting, and the second end has an internal diameter greater than the exterior diameter of the pipe.

The fitting receptacle tube member may have a variety of shapes. The plumbing construction may include the fluid conduit having an elbow shape, a T-shape or a linear shape. In addition, the fluid conduit has a stopper to serve as an end cap to prevent fluid flow past the fluid conduit. The method of joining the fluid conduit and fitting receptacle involves mechanically gripping the outer surface of the fitting after telescoping the fitting receptacle over the fitting. The new pipe for installation mechanically grips the inner surface of the connection member. Another method for the bonding of the fitting and the pipe is accomplished by welding.

The fitting receptacle tube member may have a variety of connection members. One embodiment incorporate a pipe and/or a fluid conduit on the second end of the tube member. The pipe may comprise polyvinyl chloride, plastic, polymeric substances, metals, and organosilicon compounds. The pipe may be of any diameter. Preferred diameters include 1½ inch and 2 inches for use in plumbing applications. All pipe sizes from minute diameters to infinite diameters are included within this invention.

While the presently preferred embodiments of the invention have been illustrated, other embodiments are also contemplated. Other reasonable variations and modifications to the invention are possible within the scope of the foregoing disclosure and the appended claims to the invention.

I claim:

1. A tubular construction comprising:
a tube member,
a fitting receptacle on one end of said tube member, and
a connection member on a second end of said tube member.

2. A tubular construction according to claim 1 wherein said fitting receptacle comprises a diameter sufficient to mount fittings selected from the group consisting of 1½ inch coupling, 2 inch coupling, 1½ inch elbow, 2 inch elbow, 1½ inch Y, 2 inch Y, 1½ inch T, and 2 inch T.

3. A tubular construction according to claim 1 wherein said connection member comprises a fluid conduit.

4. A tubular construction according to claim 1 wherein said connection member comprises means to receive pipe.

5. A tubular construction according to claim 1 further comprising substances selected from the group consisting of copper, steel, and iron, siloxanes, polyvinyl chloride, polyethylene, polyolefins, polybutylene, polypropylene, and polyester.

6. The tubular construction according to claim 1 wherein said tube member is a fluid flow pipe, said connection member is a standard fitting, said fitting receptacle comprises means to mount said standard fitting, and said construction forms a plumbing connection for fluid flow there through.

7. The tubular construction according to claim 6 wherein said connection member includes a first internal step means for abutment against an end of a pipe, said fitting receptacle comprises a second internal step means for abutment against an end of a universal fitting.

8. The tubular construction according to claim 6 wherein the internal diameter of said connection member receiving fluid flow when said pipe and said standard fitting are received within said connection member and said fitting receptacle is at least as large as the internal diameter of said tube member such that flow through said connection member is not restricted with respect to flow through said tube member.

9. A tubular construction between a pipe member and a fitting formed by the method comprising: mounting a fitting receptacle about the exterior circumference of an existing fitting, disposing an end of said pipe member within an opening in said fitting receptacle fitting, and then rotating said pipe member at a sufficient speed and for a sufficient period of time to form separate fluid-tight substantially concentric and coaxial friction welds between said each of said pipe member, said fitting, and said fitting receptacle

10. A method of forming a sealed, tubular connection between a pipe member and a fitting member comprising the steps of: mounting a fitting receptacle according to claim 1 about a fitting and disposing an end of a pipe member into said connection member.

11. The method according to claim 14 further comprising mounting fitting receptacle on said fitting, disposing said pipe within said fitting receptacle, applying adhesive, and sliding together.

12. A plumbing construction comprising: a fluid conduit, a fitting receptacle at one end of said fluid conduit, and a fitting at a second end of said fluid conduit.

13. A plumbing construction according to claim 12 wherein said first end comprises an internal diameter greater than an exterior diameter of said fitting, and said second end comprises an internal diameter greater than an exterior diameter of a pipe.

14. A plumbing construction according to claim 12 wherein said fluid conduit comprises shapes selected from a curve, an angle, a T-shape, a Y-shape, or a linear-shape.

15. A plumbing construction according to claim 15 wherein said fluid conduit comprises a stopper.

16. A method of forming a sealed, tubular connection between a pipe and a fitting comprising the steps of
mounting a tubular construction according to claim 1 onto a fitting, disposing an end of a pipe of within an opening of said fitting receptacle such that said fitting receptacle mechanically grips the outer surface of said fitting and said pipe mechanically grips the inner surface of said connection member.

17. A method of joining one essentially cylindrical free end of a pipe and one essentially cylindrical free end of a fitting which comprises, positioning a tubular construction according to claim 1 over a fitting segment and inserting an end portion of said pipe within said connection member.

18. A method according to claim 17 wherein the bonding of said pipe is accomplished by welding, adhesives or heat bonding.

19. A method of joining one essentially cylindrical free end of a plastic pipe and one essentially cylindrical flee end of a fitting which comprises, positioning a preformed fitting receptacle according to claim 1 with the first end telescoped over said free end of said fitting, inserting plastic pipe into the second of the fitting receptacle, and sealing.
